(19) United States
(12) Patent Application Publication
(10) Pub. No.: US 2011/0142498 A1
(43) Pub. Date: Jun. 16, 2011

(54) REPLENISHER TONER CONTAINER

(75) Inventors: Paul M. Wegman, Pittsford, NY (US); Kevin L. Maltzahn, Webster, NY (US); Wayne D. Drinkwater, Fairport, NY (US); Ricardo H. Mendoza, Webster, NY (US); David B. Playfair, Penfield, NY (US); Mark R. Vannicola, Rochester, NY (US)

(73) Assignee: Xerox Corporation, Norwalk, CT (US)

(21) Appl. No.: 12/635,803

(22) Filed: Dec. 11, 2009

(51) Int. Cl. G03G 15/08

(52) U.S. Cl. 399/262

(57) ABSTRACT

A low cost, robust and efficient replenisher toner container is provided and includes (a) a one-piece blow-molded container body having a wall defining an exterior surface of the body and an interior cavity within the body; (b) a first end, of the one-piece blow-molded container body, having a handle member; (c) a second end, of the one-piece blow-molded container body opposite the first end, including a single fill/dispense opening for filling the interior cavity with replenisher toner and for dispensing replenisher toner from the interior cavity; and (d) at least a one molded scoop member formed at the second end for efficiently delivering the replenisher toner being dispensed from the interior cavity into receiving components in the xerographic machine.

### BACKGROUND OF THE DISCLOSURE

The present disclosure is directed to xerographic printing machines, and more particularly to a low cost, robust and efficient replenisher toner container for containing and dispensing replenishment toner into a development unit of such a machine.

A typical xerographic printing machine employs a photoconductive member that is charged to a substantially uniform potential so as to sensitize the surface thereof. The charged portion of the photoconductive member is exposed to a light image of an original document being reproduced. Exposure of the charged photoconductive member selectively irradiates and dissipates the charge thereon in the irradiated areas and as a result leaves a record of an electrostatic latent image on the photoconductive member corresponding to the informational areas contained within the original document being reproduced. After the electrostatic latent image is recorded on the photoconductive member as such, the latent image is developed by bringing a relatively oppositely charged developer material into contact therewith. Generally, the electrostatic latent image is developed with dry developer material comprising carrier granules having charged toner particles that adhere electrically thereto. However, a liquid developer material may be used as well. The charged toner particles are attracted to the latent image forming a visible toner image on the photoconductive surface which can then be transferred to a copy sheet. Thereafter, the toner image is heated and permanently fused it to the copy sheet.

As the charged toner particles within the developer material is transferred as above during image development, the developer material invariably becomes depleted of toner particles, and so the level of the toner particles in the developer material must be replenished in order to maintain quality in subsequently developed images.

Accordingly, xerographic printing machines typically include a replenisher assembly that can receive a container or cartridge containing replenisher toner from which such toner is then dispensed into development unit of the machine. For image quality and operator safety reasons, it is highly desirable that these replenisher toner containers or cartridges be “white glove” standard. Accordingly, the operator's hands should not get dirty when removing or mounting a replenisher toner container within the printing machine. Additionally, when the toner container is being shipped, being opened to dispense toner particles into the printing machine, or being removed from the machine, none of the toner particles it contains should spill or escape. Furthermore, for efficiency reasons, it is highly desirable that during the dispensing phase, practically all the replenisher toner in the container should be dispensed.

Examples of a typical prior art replenisher toner containers can be found in U.S. Pat. No. 5,857,129 that discloses a cylindrical toner cartridge having an opening at one end thereof. Spiral ribs are molded into the container so that as the container is rotated about its longitudinal axis, toner particles are advanced from one end thereof to the opening therein so as to be dispensed into the development unit of the printing machine. A seal closes the opening in the container so that particles may not escape therefrom during the shipment and handling thereof.

Another example can be found in U.S. Pat. No. 7,437,107 issued Oct. 14, 2008 to Takuwa, and entitled “Toner Container in Image Forming Apparatus” which discloses a toner container for use in an image forming apparatus to discharge toner from the toner container upon rotation of the toner container in the image forming apparatus along a direction of a rotation axis of the toner container has a cylindrical body unit for containing a toner; a cylindrical end portion at a first end of the toner container, the cylindrical end portion including a first end face and a second end face; a toner supply port provided in the cylindrical end portion; and a protruded portion provided on the first end face of the first end portion, the first end face being recessed from the second end surface and positioned under said toner supply port.

Referring initially to FIG. 1, typically, prior art replenisher toner containers, like the one 70 illustrated in FIG. 1 is manufactured using a plural number of individual injection and blow molded plastic component parts, shown as a bottle portion 72 having a fill end 71 and dispense end 73, as well as an end cap portion 74 having an inboard mating end 75 and an outboard end 77. The mating end 75 of the end cap portion 74, and the dispense end 73 of the bottle portion 72, must then be fitted and jointed either by mechanically fitting them, gluing them with adhesives, heat staking, or hot-plate welding them together. The bottle portion typically has a fill opening 76 at a first end through which toner particles are fed to fill the bottle. The opening 76 requires a cap 78 after filling. At the opposite end of the bottle 72, there is a dispense opening (not shown) that requires a plug 79 to seal it during shipping. As illustrated in FIG. 1, prior art replenisher container 70 additionally includes an auger seal portion 80, a retainer 82 for the auger seal portion 80, and a shipping or post-use plug 84. Altogether there are more than 10 various component parts including a separate post-use reseal plug 84 but required to reseal the container after removal from the machine.

The shear number of component parts and the various different processes used to assemble them, besides making the typical prior art replenisher toner container 70 relatively expensive, also risk or create problems of failure, internal cleanliness and contamination. Because of the jointing in particular practically all of the toner particles within the container cannot be efficiently dispensed. Additionally, handling of the prior art container 70 can be messy because the customer is required to manually re-plug it to seal the dispense opening thereof with a separate shipping plug after using and emptying the container.

### SUMMARY OF THE DISCLOSURE

In accordance with the present disclosure, there is provided a low cost, robust and efficient replenisher toner container for holding and dispensing replenisher toner in a xerographic machine. The low cost, robust and efficient replenisher toner container includes (a) a one-piece blow-molded container body having a wall defining an exterior surface of the body and an interior cavity within the body; (b) a first end, of the one-piece blow-molded container body, having a handle member; (c) a second end, of the one-piece blow-molded container body opposite the first end, including a single fill/dispense opening for filling the interior cavity with replenisher toner and for dispensing replenisher toner from the interior cavity; and (d) at least a one molded scoop member formed at the second end for efficiently delivering the replenisher toner being dispensed from the interior cavity into receiving components in the xerographic machine.

### BRIEF DESCRIPTION OF THE DRAWINGS

Other aspects of the present disclosure will become apparent as the following description proceeds and upon reference to the drawings, in which:

FIG. 1 is an exploded perspective view of an exemplary prior art toner container;

FIG. 2 is an exploded perspective view of the replenisher toner container of the present disclosure;

FIGS. 3-5 are front side and back side views of the replenisher toner container of the present disclosure;

FIG. 6 is a plan view of the handle end of the replenisher toner container of the present disclosure;

FIG. 7 is a plan view of the fill/dispense end of the replenisher toner container of the present disclosure; and

FIG. 8 is a schematic elevational view showing a xerographic printing machine including the replenisher toner container of the present disclosure mating with a toner dispenser in the printing machine for discharging replenishment toner the container into a development unit of the machine.

### DETAILED DESCRIPTION

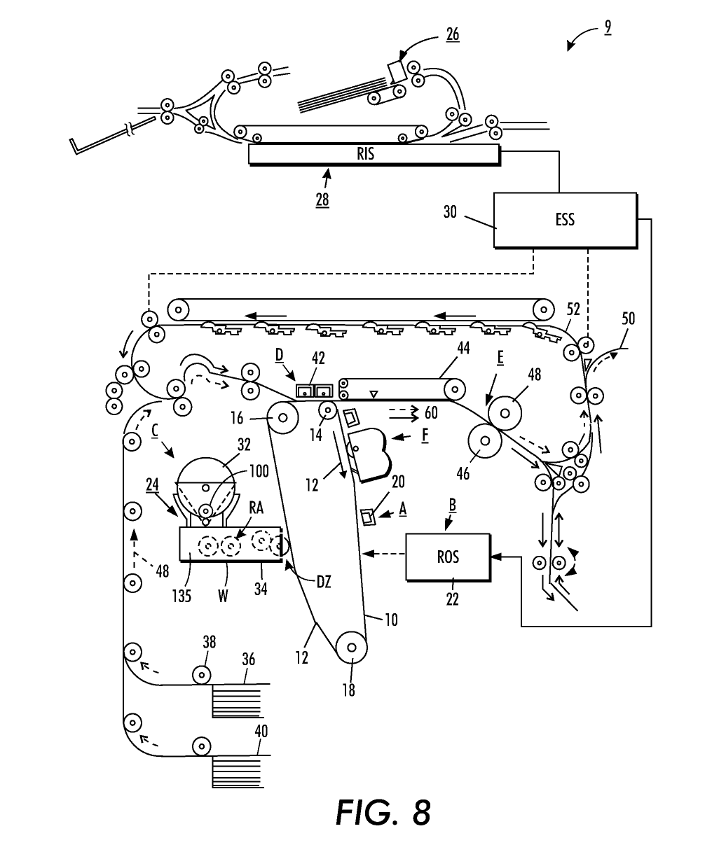

Referring initially to FIG. 8, there is shown a xerographic printing machine 9 incorporating the replenisher toner container of the present disclosure therein. The printing machine 9 includes a moveable imaging member in the form of a belt 10 having a photoconductive surface deposited on a conductive substrate. Any suitable photoconductive belt may be employed. Belt 10 advances successive portions of the photoconductive surface sequentially through the various processing stations disposed about the path of movement thereof. Belt 10 moves in the direction of arrow 12. Belt 10 is entrained about stripping roller 14, tensioning roller 16, and drive roller 18. As drive roller 18 rotates, it advances belt 10 in the direction of arrow 12 for movement passed a series of latent image forming and development stations, including latent image forming and development means.

Initially, belt 10 passes through charging station A. At charging station A, a corona generating device, indicated generally by the reference numeral 20, charges the photoconductive surface of belt 10 to a relatively high, substantially uniform potential.

After the photoconductive surface of belt 10 is charged, the charged portion thereof is advanced to an exposure station B. At the exposure station, an imaging beam generated by a raster output scanner (ROS) 22 illuminates the charged portion of the photoconductive surface. ROS 22 employs a laser with a rotating polygon mirror block to create an electrostatic latent image on the photoconductive surface of belt 10. This electrostatic latent image is developed by development unit 24. An original document is positioned in a document handler 26 on a raster input scanner (RIS), generally indicated by the referenced numeral 28. RIS 28 includes document illumination lamps, optics, a mechanical scanning drive and a charge coupled device (CCD) array. The RIS captures the entire original document and converts it to a series of raster scan lines. This information is transmitted through an electronic subsystem (ESS) 30. The output from ESS 30 controls ROS 22.

At development station C, development unit 24 develops the electrostatic latent image recorded on the photoconductive surface of belt 10. As shown, development unit 24 includes (a) a housing 34 having walls W defining a chamber 35 storing the developer material; (b) a rotatable roller assembly RA for transporting developer material from the chamber 35 to a development zone DZ to transfer toner in the developer material to a latent image on the photoconductive belt 10, thereby depleting toner levels in the developer material; and (c) a toner replenisher assembly 32 connected to the developer housing 34 for adding replenisher toner to the developer material. The toner replenisher assembly 32 as further shown includes a replenisher toner container 100 (to be described in detail below) containing and supplying the replenisher toner.

With continued reference to FIG. 8, after the electrostatic latent image is developed, the toner image continues to advance on belt 10 to transfer station D. At transfer station D, a sheet of support material is advanced from a stack 36 by sheet feeders 38. Alternatively, the sheet of support material may be advanced from stack 40. In either case, the sheet of support material is advanced to transfer station D in registration with the toner image on belt 10. A corona generating device 42 sprays ions on to the back side of the sheet of support material. This attracts the developed image from the photoconductive surface of belt 10 to the sheet of support material. A vacuum transport 44 moves the sheet of support material, in the direction of arrow 60, to fusing station E.

Fusing station E includes a heated fuser roller 46 and a backup or pressure roller 48. The backup roller is resiliently urged into engagement with the fusing roller to form a nip through which the sheet passes. In the fusing operation, the toner particles coalesce and bond to the sheet in image configuration forming a copy thereof. After fusing, the finished sheet is discharged along path 50. Alternatively, the finished sheet may be returned to transfer station D along path 52 with the opposite side positioned to be in engagement with the photoconductive surface of the belt so as to form a duplex copy. In any event, the simplex or duplex sheets are then finally advanced along path 50 to a catch tray with subsequent removal therefrom by the operator.

Invariably, after the sheet is separated from the photoconductive surface of belt 10 at the transfer station, some residual particles remain adhering thereto. These residual particles are removed from the photoconductive surface at cleaning station F. Cleaning station F includes a pair of rotatably mounted fiber brushes or a rotating brush and a blade which are electrically biased to attract particles from the photoconductive surface. The brushes are in contact with the photoconductive surface. Subsequent to cleaning, a discharge lamp, not shown, floods the photoconductive surface with light to dissipate any residual or electrostatic charge remaining thereon prior to the charging thereof for the next successive imaging cycle.

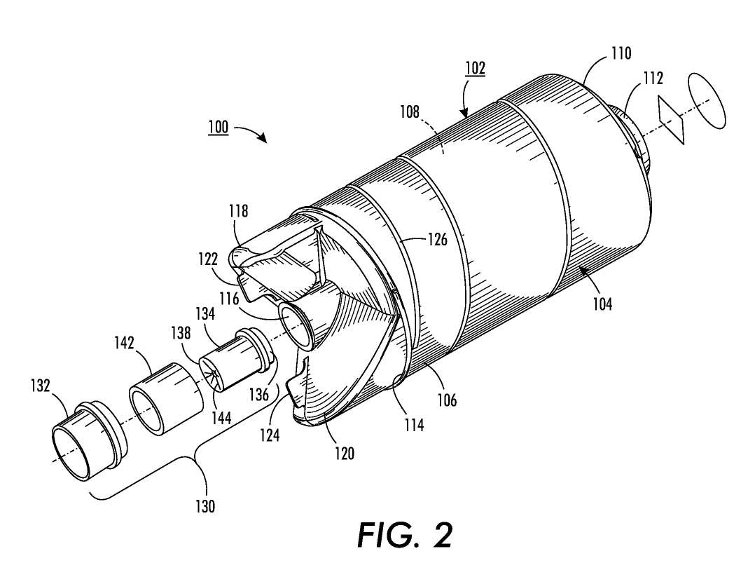

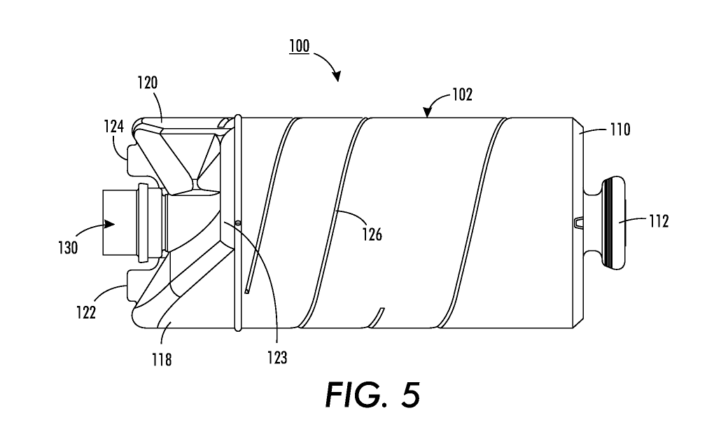

Referring now to FIGS. 2-7, there is illustrated an exploded view of the low cost, robust and efficient replenisher toner container 100 of the present disclosure. The low cost, robust and efficient replenisher toner container 100 is particularly suitable for holding and dispensing replenisher toner in the xerographic machine 9 of FIG. 8. As illustrated, the low cost, robust and efficient replenisher toner container 100 includes (a) a one-piece blow-molded container body 102 having a wall 104 defining an exterior surface 106—of the body and an interior cavity 108 within the body; (b) a first end 110, of the one-piece blow-molded container body, having an operator handle member 112; (c) a second end 114, of the one-piece blow-molded container body opposite the first end, including a single fill/dispense opening 116 for filling the interior cavity 108 with replenisher toner and for dispensing replenisher toner from the interior cavity; and (d) at least one molded scoop member 118, 120 formed at the second end for efficiently delivering the replenisher toner being dispensed from the interior cavity 108 into receiving components in the xerographic machine 9 of FIG. 8.

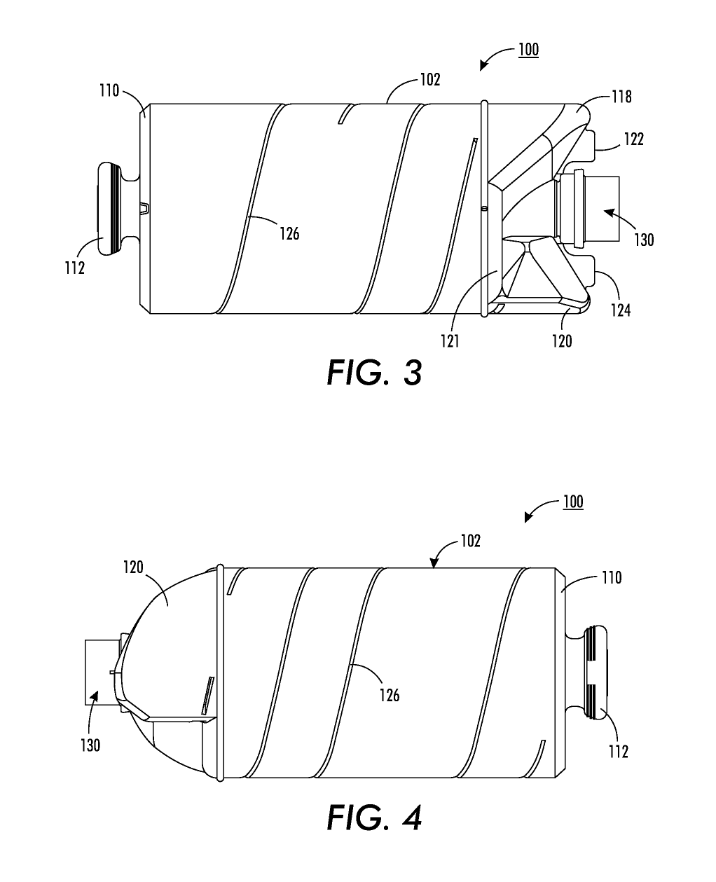

Specifically, the one-piece blow-molded container body 102 is made for example of high density polyethylene body. As shown, the second end, fill/dispense 114 of the one-piece blow-molded container body 102 includes two scoop members 118, 120 for efficiently delivering the replenisher toner from within container 100 to the development unit 24 (during replenisher toner dispensing) as the container 100 is being rotated around its longitudinal axis within the replenisher assembly 32 of the machine 9. The scoop members 118, 120 are separated at the second end 114 by two recesses 121 (labeled in FIG. 3) and 123 (labeled in FIG. 5) as shown. Additionally, as shown, the second end 114 also includes two molded drive tabs 122, 124 for engaging a drive assembly (not shown) within the machine 9 for rotating the container 100 as desired. The wall 104 of the one-piece blow-molded body 102 of the container 100 as shown has a molded-in, double-pitch spiral groove 126 formed on both the exterior and exterior surfaces thereof for directing and moving the replenisher toner within the interior cavity from the first end toward the second, dispense end 114 of the one-piece blow-molded body of the container 100 as the container 100 is being rotated.

As shown in FIGS. 2-7 the replenisher toner container 100 includes a hub assembly 130 that is connected to the second, fill/dispense end 114 of the one-piece blow-molded body 102 thereof. The hub assembly 130 has a hub member 132, and a plug device 134 within the hub member for plugging and sealing the single fill/dispense opening 116 of the second end 114. The plug device 134 is made of a resilient material for example high-density polyethylene. The plug device 134 as such has an inboard end 136 for fitting into the fill/dispense opening 116 of the second end 114, and an opposite outboard end 138 that includes a hole 140 therein for engagement with replenisher assembly 32 components within the machine 9.

The hub assembly 130 further includes a seal member 142, such as an open cell foam member, mounted within the hub member 132 for sealing axially and radially against the hub member 132 and against the plug device 134 in order to prevent replenisher toner from leaking out of the hub assembly. The hub member 132 also includes a snap-in portion around the outside circumference of hub member 132 for engaging and holding the hub assembly 130 securely against the one-piece blow-molded body 102. The snap-in portion for example includes tabs that upon insertion engage with a shoulder associated with the opening 116 of the one-piece blow-molded body 102.

As further shown, the wall 104 of the one-piece blow-molded container body includes a molded—in spiral groove 126 formed therein for directing and moving replenisher toner within the interior cavity 108 from the first end 110 towards the second end 114 when the replenisher toner container is rotated with in the machine 9.

More specifically, as shown in FIG. 2, the hub assembly 130 is a three component assembly comprised of an injection-molded polyethylene hub member 132, an open cell foam seal member 142, and a plug device 134 made of a resilient material such as high-density polyethylene. The three component hub assembly 130 as such is shipped fully assembled from the factory ready for snapping into the single fill/dispense opening 116 of the second end 114 of the container body 102, after the container 100 has been filled with replenisher toner. The hub assembly 130 thus functions to seal the single fill/dispense opening 116 in order to prevent leakage of replenisher toner from the container 100.

The hub member 132 houses the seal member 142, and has snap for snapping into the fill/dispense opening 116 of the one-piece blow-molded container body 102 and engaging mating female snap features (not shown), thereby holding the hub assembly 130 securely in place on the one-piece-blow-molded body. The snap-in portion around the outside circumference of hub member 132 includes molded tabs that engage a shoulder feature (not shown) associated with the opening 116 of the one-piece blow-molded body 102.

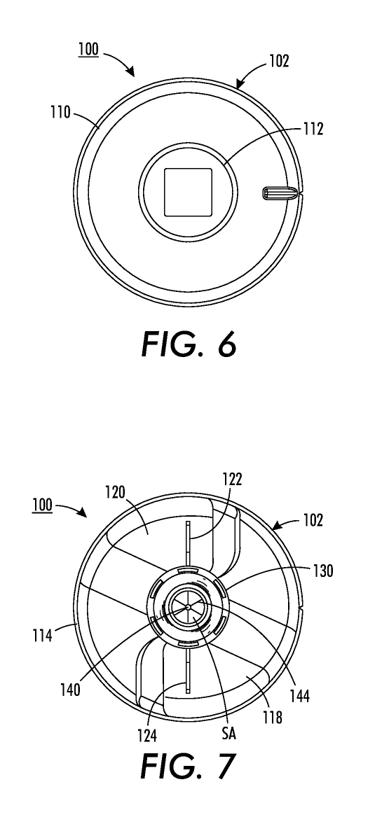

The seal member 142 is a cylindrical open-cell foam member that provides a seal and prevents replenisher toner from leaking from opening 116 and around the hub member 132 and the plug device 134 prior to use. The seal member 142 does so by sealing both axially and radially against the opening 116, the hub member 132 and the plug device 134. The plug device 134 on its own also engages the inside of the wall 104 of the one-piece blow-molded container body 102 with an interference fit to provide the primary and substantial seal against replenisher leakage from the interior cavity 108. However, any replenisher toner that manages to bypass the plug device 134 will be stopped by the seal member 142. The hole 140 in the outboard-end 138 of the plug device 134 serves for engaging a bayonet-like post (not shown) at the end of an auger tube (not shown) in the replenisher assembly 132 of the machine 9. As shown in FIGS. 2 and 7 in particular, the area SA around the hole 140 includes slits 144 for allowing the hole 140 to open to a larger diameter when the bayonet-post engages the plug device 134, but for also allowing the hole to close back to a narrow diameter as the bayonet-post disengages from the plug device 134.

The plug device 134 is thus held by and to the bayonet-post of during container emptying. The plug device 134 is reseated in the seal member 142 and disengaged from the bayonet-post when the container is removed from the machine 9. The plug device 134 is designed such that the force for unseating the plug device from the inside of the wall 104 of the one-piece blow-molded container body 102 with an interference fit is lower than the force for engaging the plug device with the bayonet-post, thereby assuring that the plug device engages and is held securely until the container 100 is removed from the machine 9. Thus the plug device 134 is designed such that it is fully reseated in the open cell foam seal member 142 before it can become disengaged from the bayonet-post, thereby 100% of the time reliably resealing each replenisher toner container 100 after it is emptied from use in the machine 9.

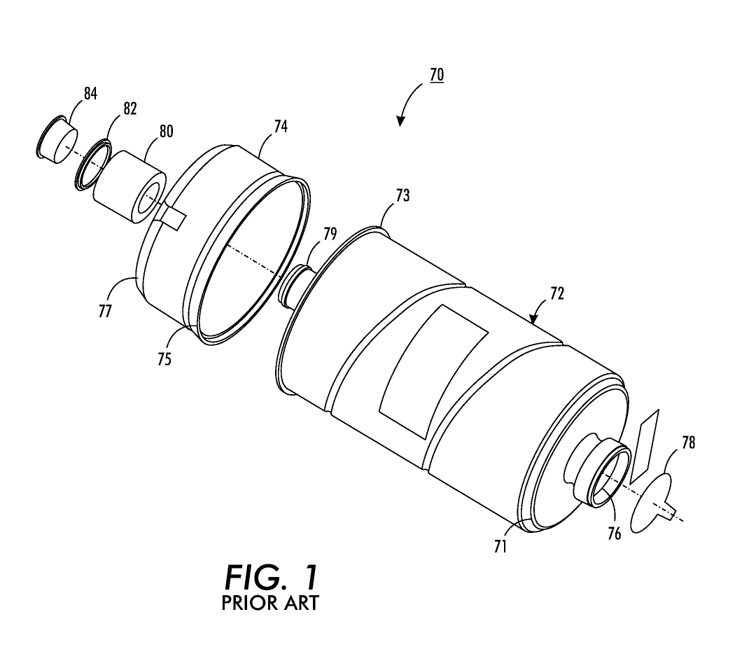

Unlike in the case of the replenisher toner container 100 of the present disclosure where each replenisher toner container reliably resealed 100% of the time as above, the prior art container 70 was found to only reseal about 5% of the containers after emptying from use in a machine 9, thereby requiring customers thereof to manually plug the dispense opening thereof with a separate shipping plug 84 (FIG. 1) after such emptying.

Advantageously as shown in the differences between FIGS. 2 and 1, the replenisher toner container 100 of the present disclosure has only 7 component parts as compared to the prior art container 70 (FIG. 1) which has at least 10 component parts. More importantly, the replenisher toner container 100 of the present disclosure (FIG. 2) does not require the hot-plate, ultrasonic welding, and heat staking processes for joining component parts as does the prior art container 70, and therefore advantageously does not risk or create problems of failure, internal cleanliness or contamination as does the prior art container 70.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A replenisher toner container for holding and dispensing replenisher toner in a xerographic machine, the replenisher toner container comprising:
(a) a one-piece blow-molded container body having a wall defining an exterior surface thereof and an interior cavity therewithin;
(b) a first end of said one-piece blow-molded container body including a handle member;
(c) a second end of said one-piece blow-molded container body opposite said first end, said second end including a single fill/dispense opening for filling said interior cavity with replenisher toner and for dispensing replenisher toner from said interior cavity; and
(d) at least one molded scoop member formed at said second end for efficiently delivering the replenisher toner being dispensed from said interior cavity into the xerographic machine.

2. The replenisher toner container of claim 1, including a hub assembly connected to said fill/dispense end, said hub assembly having a hub member and a plug device within said hub member for plugging and sealing said single fill/dispense opening of said second end.

3. The replenisher toner container of claim 1, wherein said one-piece blow-molded container body is made of high density polyethylene.

4. The replenisher toner container of claim 1, including a pair of drive tabs formed at said second end for engaging, and being used by, a drive assembly to drive and rotate said replenisher container about its longitudinal axis within the xerographic machine.

5. The replenisher toner container of claim 1, wherein said wall of said one-piece blow-molded container body includes a molded—in spiral groove formed therein for directing and moving replenisher toner within said interior cavity from said first end towards said second end when said replenisher toner container is rotated with in the machine.

6. The replenisher toner container of claim 2, wherein said plug device is made of a resilient material.

7. The replenisher toner container of claim 2, wherein said hub assembly further includes a seal member within said hub member for sealing axially and radially against said hub member, against said plug device, and against an inside of said wall of said one-piece blow-molded body around said fill/dispense opening to prevent replenisher toner from leaking from said interior cavity when plugged by said hub assembly.

8. The replenisher toner container of claim 2, wherein said hub member includes a snap-in member for snapping into the one-piece blow-molded body thereby engaging the one-piece blow-molded body and holding the hub assembly securely in place on the one-piece blow-molded body.

9. The replenisher toner container of claim 6, wherein said plug device has an inboard end for snapping into said fill/dispense opening of said second end, and an opposite outboard end including a hole therein for engagement within the machine.

10. The replenisher toner container of claim 7, wherein said seal member comprises an open-cell foam member.

11. A development unit for use in a xerographic reproduction machine for developing latent images with developer material, comprising:
(a) a housing having walls defining a chamber storing the developer material;
(b) a rotatable roller assembly for transporting developer material from said chamber to a development zone to transfer toner in said developer material to a latent image thereby depleting toner levels in said developer material;
(c) a toner replenisher assembly connected to said developer housing for adding replenishing toner to said developer material, said toner replenisher assembly including a replenisher toner container comprising:
(i) a one-piece blow-molded container body having a wall defining an exterior surface thereof and an interior cavity therewithin;
(ii) a first end of said one-piece blow-molded container body including a handle member;
(iii) a second end of said one-piece blow-molded container body opposite said first end, said second end including a single fill/dispense opening for filling said interior cavity with replenisher toner and for dispensing replenisher toner from said interior cavity; and
(iv) at least one molded scoop member formed at said second end for efficiently delivering the replenisher toner being dispensed from said interior cavity into the xerographic machine.

12. The development unit of claim 11, including a hub assembly connected to said fill/dispense end, said hub assembly having a hub member and a plug device within said hub member for plugging and sealing said single fill/dispense opening of said second end.

13. The development unit of claim 11, wherein said one-piece blow-molded container body is made of high density polyethylene.

14. The development unit of claim 11, including a pair of drive dogs formed at said second end for engaging, and being used by, a drive assembly to drive and rotate said replenisher container within the xerographic machine.

15. The development unit of claim 11, wherein said wall of said one-piece blow-molded container body includes a molded—in spiral groove formed therein for directing and moving replenisher toner within said interior cavity from said first end towards said second end when said replenisher toner container is rotated with in the machine.

16. A xerographic reproduction machine comprising:
(a) a moveable imaging member including an imaging surface;
(b) latent imaging means for forming a latent electrostatic toner image on said imaging surface of said moveable imaging member;
(c) a development unit mounted adjacent a path of movement of said moveable imaging member for developing latent images with developer material, said developer unit having a replenisher assembly including a replenisher toner container comprising:
(i) a one-piece blow-molded container body having a wall defining an exterior surface thereof and an interior cavity therewithin;
(ii) a first end of said one-piece blow-molded container body including a handle member;
(iii) a second end of said one-piece blow-molded container body opposite said first end, said second end including a single fill/dispense opening for filling said interior cavity with replenisher toner and for dispensing replenisher toner from said interior cavity; and
(iv) at least one molded scoop member formed at said second end for efficiently delivering the replenisher toner being dispensed from said interior cavity into the xerographic machine.

17. The xerographic reproduction machine of claim 16, including a hub assembly connected to said fill/dispense end, said hub assembly having a hub member and a plug device within said hub member for plugging and sealing said single fill/dispense opening of said second end.

18. The xerographic reproduction machine of claim 16, including a pair of drive tabs formed at said second end for engaging, and being used by, a drive assembly to drive and rotate said replenisher container within the xerographic machine.

19. The xerographic reproduction machine of claim 16, wherein said wall of said one-piece blow-molded container body includes a molded—in spiral groove formed therein for directing and moving replenisher toner within said interior cavity from said first end towards said second end when said replenisher toner container is rotated with in the machine.

20. The xerographic reproduction machine of claim 17, wherein said hub assembly further includes a seal member within said hub member for sealing axially and radially against said hub member, against said plug device, and against an inside of said wall of said one-piece blow-molded body around said fill/dispense opening to prevent replenisher toner from leaking from said interior cavity when plugged by said hub assembly.
